(19) United States
(12) Patent Application Publication
(10) Pub. No.: US 2016/0121798 A1
(43) Pub. Date: May 5, 2016

(54) CAR MOUNT

(71) Applicant: ACTOR INTERNATIONAL CORPORATION, Taipei (TW)

(72) Inventors: KUANG-LI LEE, Taipei (TW); CHENG-LANG HSU, Taipei (TW)

(73) Assignee: ACTOR INTERNATIONAL CORPORATION, Taipei (TW)

(21) Appl. No.: 14/531,281

(22) Filed: Nov. 3, 2014

(51) Int. Cl. B60R 7/00

(52) U.S. Cl. CPC B60R 7/00

(57) ABSTRACT

A car mount includes a base assembly having a supporting surface and a first gear structure. A main body includes a cover and is disposed on the supporting surface. The cover has a peripheral part, wherein the cover retreats inwardly from the peripheral part along a direction opposite to the base assembly to form a recession space. A rotor includes an axle body and a second gear structure. The axle body is accommodated in the recession space. A part of the axle body protrudes through the cover. The second gear structure is formed on a surface of the rotor facing the supporting surface. A first ring housing is rotatably disposed on the main body and connects the axle body. The first ring housing is capable of operating in a lock mode and an unlock mode for driving the rotor approaching to or departing from the supporting surface.

### BACKGROUND OF THE DISCLOSURE

1. Field of the Disclosure

The present invention relates to a car mount; particularly, the present invention relates to a car mount for fixing an electronic device and the car mount has a design of selectively rotating the electronic device to different positions.

2. Description of the Related Art

The car mount utilized for fixing an electronic device can facilitate users viewing driving information such as navigation map and real-time traffic information. Traditional car mount has several installation types. For example, one type thereof is adopting a suction base, and another type is adopting an adhesive tape. For the car mount adopting the adhesive tape, it may provide insufficient adhesive force and have residue problem.

For the suction base, the suction base is usually made of silicone (i.e. a silicone suction base); however, the suction force provided by the car mount adopting the silicone suction base may be unstable. For example, the silicone suction base has aging problem under high temperature. Besides, repeatedly removing and attaching the suction base may greatly reduce the lifetime of the suction base.

Furthermore, due to insufficient adhesive/suction force, traditional car mounts mentioned above may suddenly detach and drop from an installation surface, causing damage to the electronic device fixed thereon, and it is also dangerous to a driver. As such, the structure of traditional car mounts are required to improved.

### SUMMARY OF THE DISCLOSURE

It is an object of the present invention to provide a car mount with gear structures to enhance the structural stability.

A car mount includes a base assembly having a supporting surface and a first gear structure disposed corresponding to the supporting surface. A main body includes a cover. The main body is disposed on the supporting surface, and the cover has a peripheral part, wherein the cover retreats inwardly from the peripheral part along a direction opposite to the base assembly to form a recession space. A rotor includes an axle body and a second gear structure. The axle body is accommodated in the recession space. A part of the axle body protrudes through the cover along the direction opposite to the base assembly. The second gear structure is formed on a surface of the rotor facing the supporting surface. A first ring housing is rotatably disposed on the main body and connects the part of the axle body protruding through the cover. The first ring housing is capable of operating in a lock mode and an unlock mode for driving the rotor approaching to or departing from the supporting surface.

### BRIEF DESCRIPTION OF THE DRAWINGS

FIG. 1A is a top exploded view of a car mount of the present invention;

FIG. 1B is a bottom exploded view of a car mount of the present invention;

FIG. 2A is a schematic view of a first ring housing of the present invention placed upside down;

FIGS. 2B and 2C are schematic views of a rotor positioned at different height inside a main body;

FIG. 3 is a bottom view of a rotor accommodated in a recession space of the main body;

FIG. 4A is a side view of the main body combining the rotor;

FIG. 4B is a cross-sectional view of a base of the present invention;

FIG. 5A is a schematic view of the base and a pressing plate placed upside down;

FIG. 5B is a schematic view of the base combining the pressing plate;

FIGS. 6A to 6C are schematic views of the car mount operating in a unlock mode;

FIGS. 7A to 7C are schematic views of the car mount operating in an adjusting mode;

FIGS. 8A to 8C are schematic views of the car mount operating in a lock mode;

FIG. 9 is a schematic view of an embodiment of the main body combining a base assembly; and

FIG. 10 is schematic view of an embodiment of the car mount of the present invention.

### DETAILED DESCRIPTION OF THE PREFERRED EMBODIMENT

The present invention provides a car mount. In a preferred embodiment, the car mount can be utilized to fix an electronic device, such as a mobile phone, a personal digital assistant (PDA), or a GPS navigator.

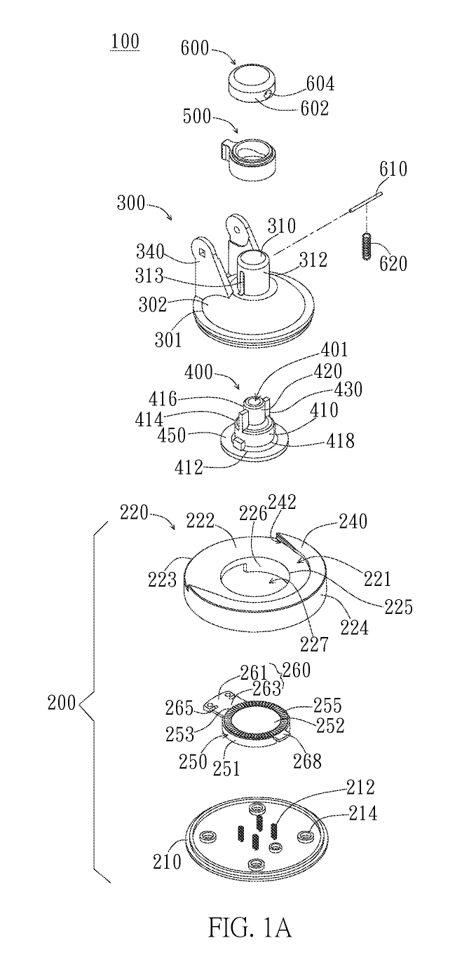

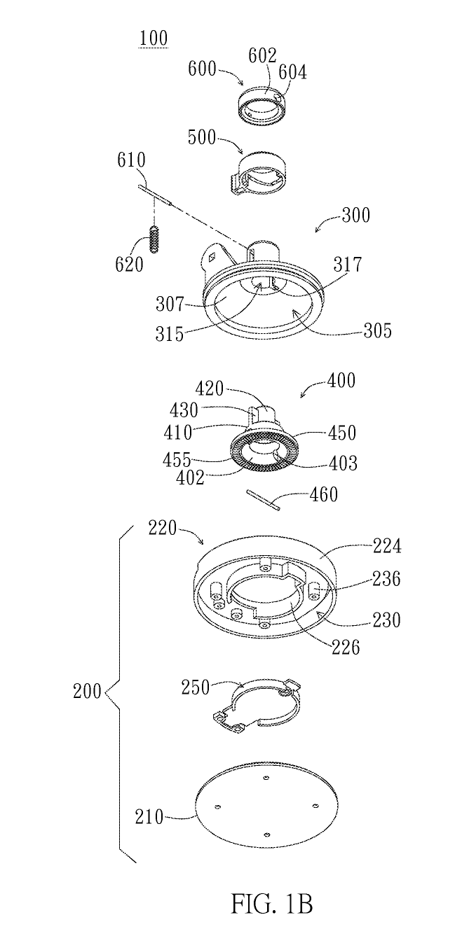

FIG. 1A is a top exploded view of a car mount of the present invention, and FIG. 1B is a bottom exploded view of a car mount of the present invention. As shown in FIG. 1A, the car mount 100 includes a base assembly 200, a main body 300, and a rotor 400. The base assembly includes a bottom plate 210, a base 220, and a pressing plate 250. A plurality of connectors 214 is form on the bottom plate 210, and at least one spring 212 (here called “second spring”) is disposed on the bottom plate 210.

The base 220 is disposed on the bottom plate 210. As shown in FIG. 1A, the base 220 has a supporting plate 221 and an outer sidewall 224 connected a periphery 223 of the supporting plate 221. The supporting plate 221 has a supporting surface 222; besides, the supporting plate 221 encircles with respect to the center of the base 220 and forms a hollow area 227. As shown in the hollow area 227, the supporting plate 221 has an inner sidewall 226, i.e. the inner sidewall 226 is connected along an inner periphery 225 of the supporting plate 221. As shown in FIG. 1B, the supporting plate inwardly forms a recession part 230 from the outer sidewall 224. A plurality of first posts 236 is disposed in the recession part 230 and formed on a surface of the supporting plate opposite to the supporting surface. The plurality of first posts 236 can insert in the plurality of connectors 214 (see FIG. 1A) to combine the base 220 with the bottom plate 210.

The pressing plate 250 is located between the base 220 and the bottom plate 210. Specifically, the pressing plate 250 can be disposed inside the recession part 230 (see FIG. 1B). As shown in FIG. 1A, the pressing plate 250 includes a pressing part 251, a first engagement part 260, and a second engagement part 268. The pressing part 251 includes an outer surface 252 and a first gear structure 255. The outer surface 252 corresponds to the hollow area 227. The first gear structure 255 is formed on the outer surface 252 and arranged in a circular fashion. Besides, a plurality of second springs 212 is evenly distributed in a projection region of the pressing part 251. In other embodiment, the number of the second spring 212 can be adjusted depending on requirement. As shown in FIG. 1A, the first engagement part 260 and the second engagement part 268 are connected a periphery 253 of the pressing part 251. Specifically, the first engagement part 260 includes a fixing part 261 and a connecting part 263. The connecting part 263 connects the periphery 253 of the pressing part 251 and extends outwardly away from the center of the outer surface 252. The fixing part 261 is located at the end portion of the first engagement part 260. As shown in FIG. 1A, the fixing part 261 connects the connecting part 263, wherein a neck portion 265 is formed between the fixing part 261 and the connecting part 263. On the other hand, the second engagement part 268 connects the periphery 253 of the pressing part 251 opposite to the first engagement part 260 and extends outwardly away from the center of the outer surface 252.

The main body 300 is disposed on the supporting surface 222. As shown in FIG. 1A, the main body 300 includes a cover 302 and an axle cover 310 disposed on the cover 302. The cover 302 has a peripheral part 301, and the axle cover 310 has a sidewall 312. An opening 313 is formed on the sidewall 312. Besides, at least one arm 340 is disposed on the cover 302, extended away from the center of the cover 302 for fixing an electronic device (not shown). As shown in FIG. 1B, a pair of arms 340 is extended away from the axle cover 310. As shown in FIG. 1B, the cover 302 retreats inwardly from the peripheral part 301 along a direction opposite to the base assembly 200 to form a recession space 305. Specifically, the axle cover 310 has a concave part 315 inside thereof and communicates the recession space 305. In other words, the concave part 315 and the recession space 305 together form an accommodation space for accommodating the rotor 400.

As shown in FIG. 1B, the rotor 400 includes an axle body 410 and a second gear structure 455. The axle body 410 is accommodated in the recession space 305. Besides, a part of the axle body 410 can protrudes through the cover 302 along the direction opposite to the base assembly 200. The second gear structure 455 is formed on a surface of the rotor 400 facing the supporting surface 222 (referring to FIG. 1A). Specifically, the second gear structure 455 is formed on a bottom surface of a pressing disc 450 and is arranged in a circular fashion. In addition, as shown in FIG. 1B, the axle body 410 is hollow and has an inner surface 402. A groove 403 is formed on the inner surface 402 (near a bottom portion 418 of the axle body 410), and a first cross rod 460 is engaged in the groove 403.

Turning back to FIG. 1A, the rotor 400 includes a core shaft 420 disposed on a top portion 416 of the axle body 410. The axle body 410 has a shoulder portion 414. At least one side lug 430 is disposed at the shoulder portion 414 and connected the core shaft 420. In one embodiment, a pair of side lugs 430 are provided and formed at opposite sides of the core shaft 420 along a radial direction of the axle body 410. The number and position of the side lug 430 corresponds to that of the opening 313 and can be modified as requirement. Besides, the pressing disc 450 is connected a bottom periphery 412 of the axle body 410. The second gear structure 455 is formed on the bottom surface of the pressing disc 450 facing the supporting surface 222. As shown in FIG. 1B, a chute 317 is formed on an inner surface 307 of the main body 300 and extend toward the concave part 315 of the axle cover 310. In one embodiment, a pair of chutes 317 is provided, corresponding to and communicating the opening 313. As such, the side lug 430 can be put in the chute 317 and protrudes outside the opening 313 through the cover 302 while combining the main body 300 with the rotor 400.

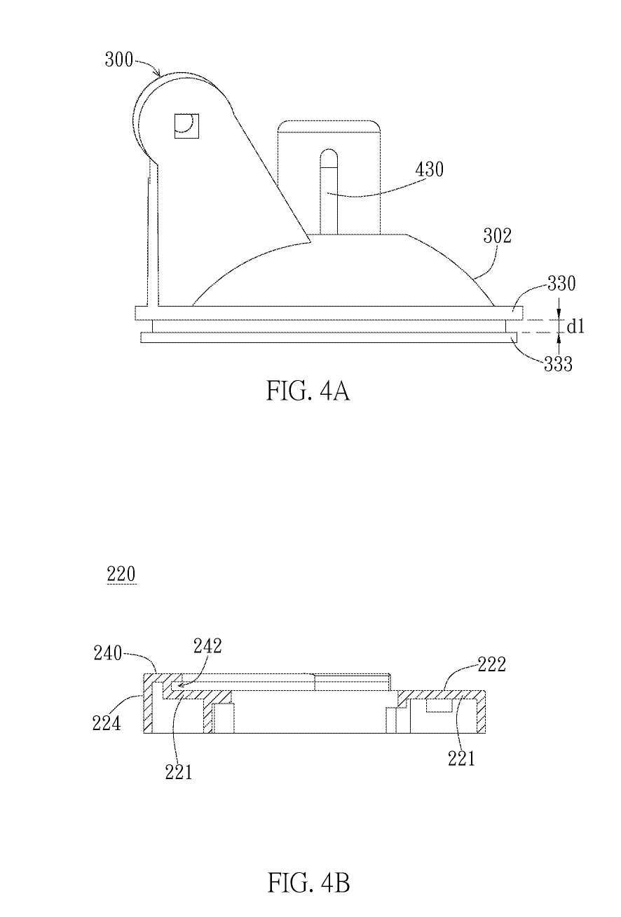

In addition to the base assembly, the main body, and the rotor, the car mount further includes a first ring housing and a second ring housing. As shown in FIGS. 1A and 1B, the first ring housing 500 is rotatably disposed on the main body 300 and connects the part of the axle body 410 protruding through the cover 302 (i.e. connects the side lug 430). The first ring housing 500 is capable of operating in different modes for driving the rotor 400 approaching to or departing from the supporting surface 222. The second ring housing 600 includes at least one through hole 604 formed on a sidewall 602 of the second ring housing 600 along a radial direction. The number and position of the thorough hole 604 corresponds to that of the opening 313 and can be modified as requirement. Besides, a second cross rod 610 penetrates the through hole 604 for disposing in the second ring housing 600. Specifically, the second cross rod 610 inserts into the through hole 604 and the opening 313 for disposing inside the axle cover 310. As shown in FIG. 1B, one end of a first spring 620 hooks the second cross rod 610; in addition, the other end of the same hooks the first cross rod 460 (see FIG. 3). In other words, the first spring 620 is disposed inside the main body 300 and hooks the first rod 460 through the hollow space of the rotor 400.

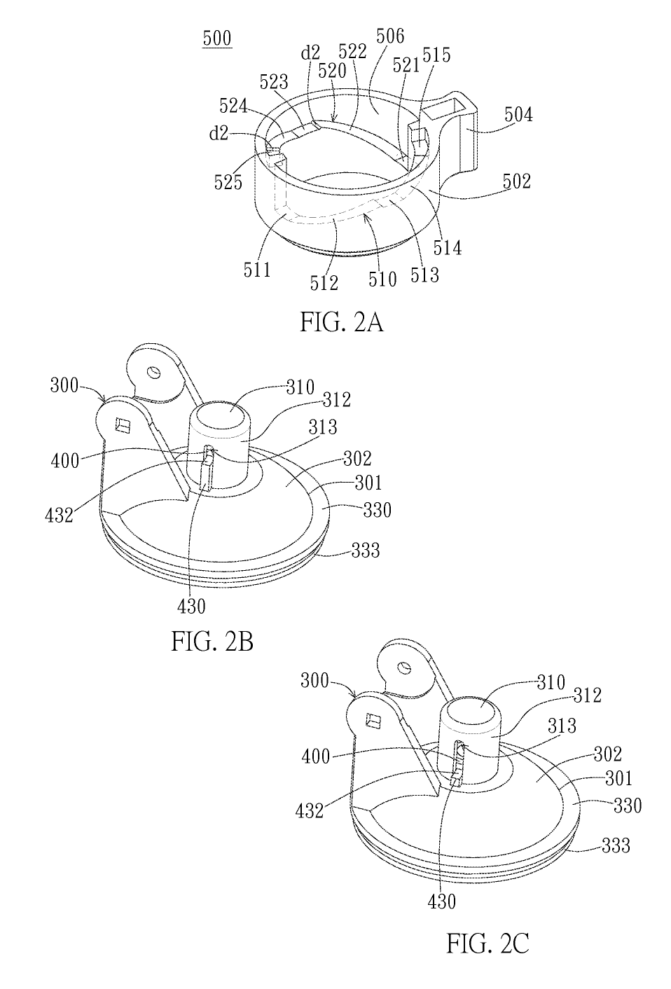

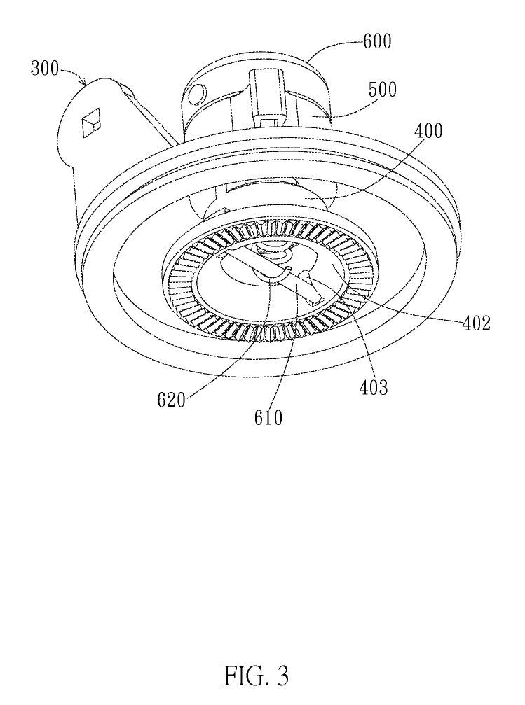

FIG. 2A is a schematic view of the first ring housing of the present invention placed upside down. As shown in FIG. 2A, the first ring housing 500 includes a holder 504 is connected a sidewall 502 of the first ring housing 500. A tread is formed on an inner surface 506 of the first ring housing 500 for contacting a top surface 432 of the side lug 430 and driving the rotor moving downward (see FIGS. 2B and 2C). In other words, the tread is formed corresponding to the position of the side lug 430. As shown in FIG. 2A, the tread includes a plurality of platforms spacedly disposed at different height. Specifically, the tread includes two sub-portions (here called a first tread 510 and a second tread 520). As shown in FIG. 2A, the first tread 510 and the second tread 520 are rotational symmetry with respect to a rotating axis of the first ring housing 500. The first tread 510 includes platforms 511, 513, and 515. An inclined plane 512 is connected between the platform 511 and platform 513, and an inclined plane 514 is connected between the platform 513 and platform 514. Similarly, the second tread 520 includes platforms 521, 523, and 525. An inclined plane 522 is connected between the platform 521 and platform 523, and an inclined plane 524 is connected between the platform 523 and platform 524.

FIGS. 2B and 2C are schematic views of a rotor positioned at different height inside a main body. As shown in FIGS. 2B and 2C, the main body 300 is combined with the rotor 400. As mentioned above, a part of the axle body protrudes through the cover 302 along the direction opposite to the base assembly. As shown in FIG. 2B, the side lug 430 protrudes through the cover 302 from the opening 313. Besides, the main body 300 includes an upper ring 330 and a lower ring 333. The upper ring 330 is connected the cover 302 along the peripheral part 301. The lower ring 333 is connected a bottom part of the cover 302 and has a height difference with respect to the upper ring 330. The lower ring 333 is attached to the supporting surface 222 (referring to FIG. 1A).

As mentioned above, the tread of the first ring housing 500 can contact the top surface 432. In view of FIG. 2A, in the second tread 520, a stage difference (d2) is formed between the platform 523 and the inclined plane 522, and another stage difference is formed between the platform 525 and the inclined plane 524. Similarly, stage differences also formed on the first tread 510 (not shown) corresponding to stage differences formed on the first tread 510. By this design, the stage difference can retain the side lug 430 on the platform when the side lug 430 moves to the platform (such as the platform 523). As to the operating mechanism, the first ring housing 500 is capable of operating in a lock mode for driving the rotor 400 approaching to the supporting surface, i.e. when the first ring housing 500 drives the rotor 400 approaching the supporting surface, the tread can apply a force on the top surface 432 of the side lug 430 to push the rotor 400 moving downward. For example, when the side lug 430 contacts the platform 511, the side lug is at a higher position (Shown in FIG. 2B); when the side lug 430 contacts the platform 513, the side lug is at a lower position (Shown in FIG. 2C).

FIG. 3 is a bottom view of a rotor accommodated in a recession space of the main body. As shown in FIG. 3, the first ring housing 500, the second ring housing 600, and the rotor 400 are combined with the main body 300. The second cross rod 610 is engaged in the groove 403, and one end of the first spring 620 hooks the second cross rod 610. As such, the first ring housing 500 is capable of operating in a an unlock mode for driving the rotor departing from the supporting surface, i.e. when the first ring housing 500 drives the rotor 400 departing from the supporting surface, the first spring 620 can apply a force on the first cross rod 610 to pull the rotor moving upward.

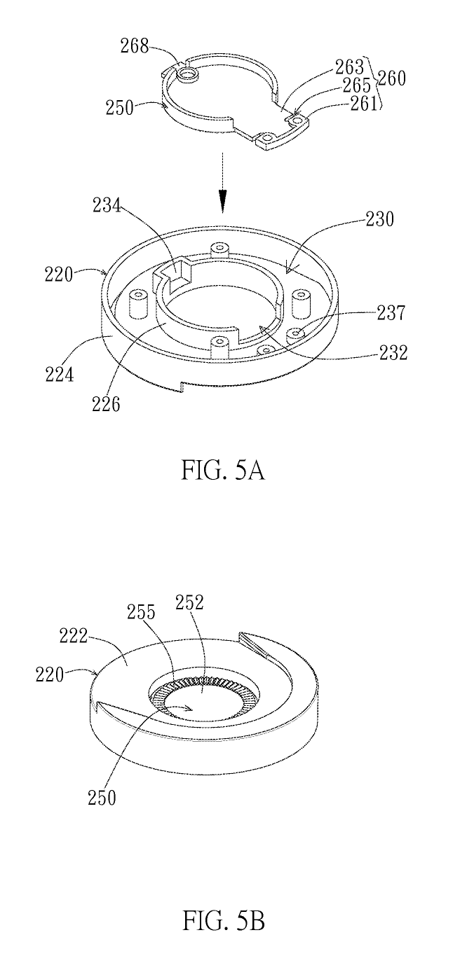

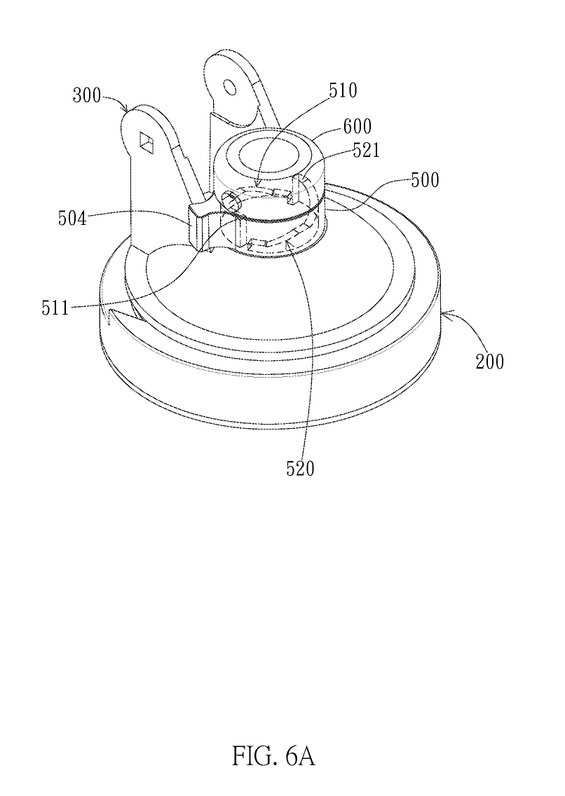

FIG. 4A is a side view of the main body combining the rotor. As shown in FIG. 4A, the side lug 430 is accommodated in the main body 300. The main body includes the upper ring 330 and the second ring 333 connected the bottom part of the cover 302. Besides, the height difference (d1) is formed between the upper ring 330 and the lower ring 333.

FIG. 4B is a cross-sectional view of a base of the present invention. As shown in FIG. 4B, the base 220 includes a top plate 240 disposed on the supporting plate 222. The top plate 240 connects the outer sidewall 224 and forms a curved opening 242 along the periphery 223 of the supporting plate 221 (referring to FIG. 1A). As shown in FIGS. 4A and 4B, the lower ring 333 can be installed in the curved opening 242 so that the main body 300 is combined with the base 220. In other words, the high difference (d1) preferably matches to the thickness of the top plate 240, and the curved opening 242 preferably matches to the thickness of the lower ring 333.

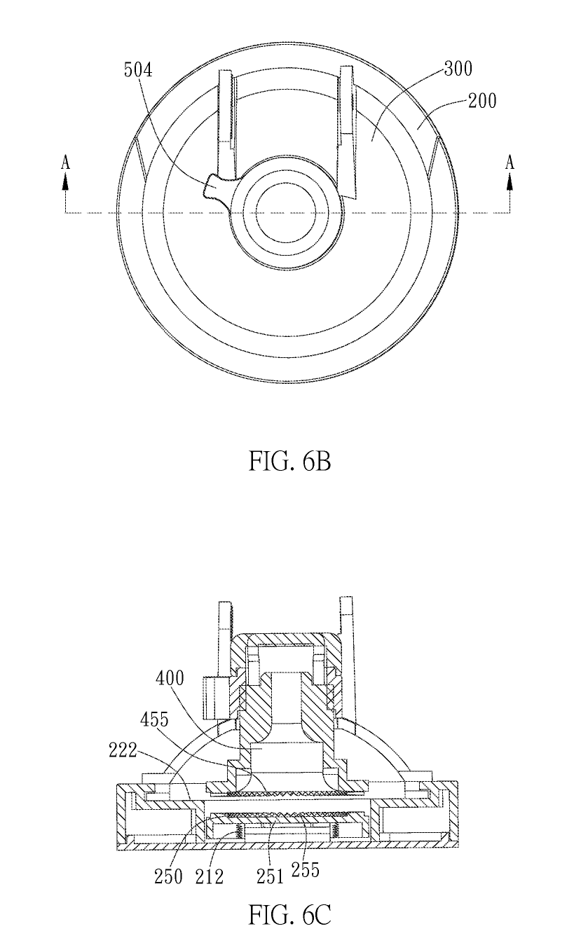

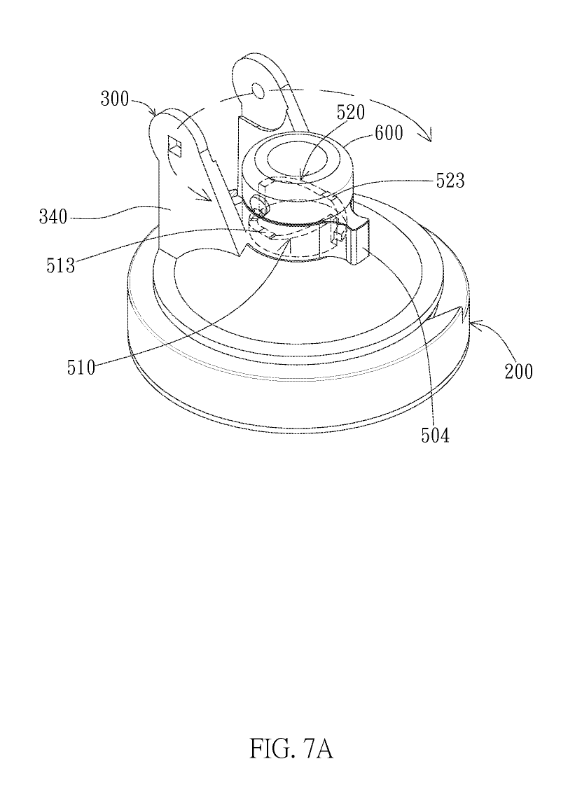

FIG. 5A is a schematic view of the base and a pressing plate placed upside down. FIG. 5B is a schematic view of the base combining the pressing plate. As shown in FIG. 5A, the base includes the inner sidewall 226 which forms a concave part 234 at one side and forms a breach 232 opposite to the concave part 234. The pressing plate 250 includes the first engagement part 260 and the second engagement part 268. The first engagement part 260 and the second engagement part 268 are designed in a form of tab. When the pressing plate 250 is combined with the base 220, the second engagement part 268 is accommodated in the concave part 234, and the first engagement part 260 is accommodated in the recession part 230. Specifically, the neck portion 265 engages the inner sidewall 226 at the breach 232, and the connecting part 263 is fixed to two second posts 237 near the breach 232. As shown in FIG. 5B, after combing the pressing plate 250 with the base 220, the first gear structure 255 is disposed corresponding to the supporting surface 222.

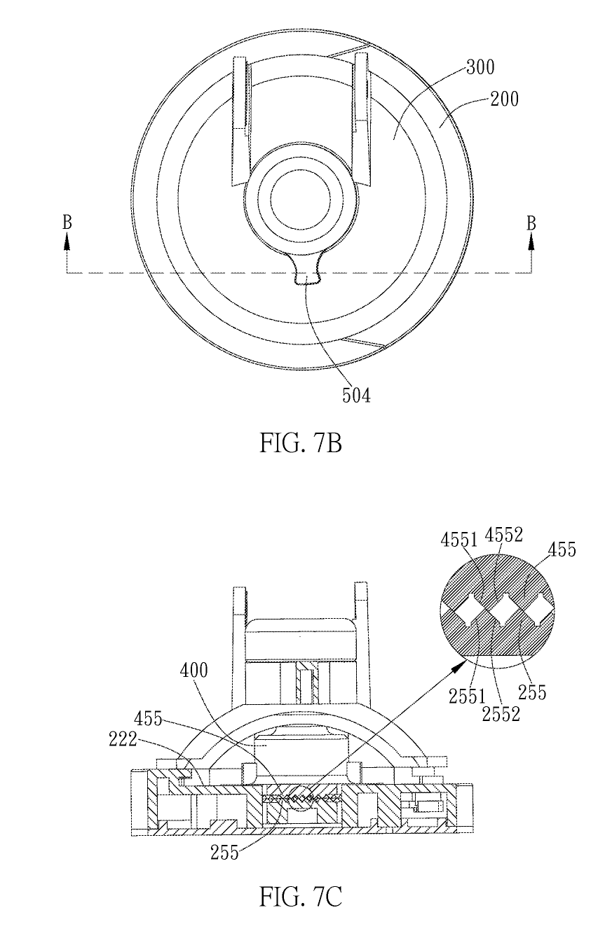

As mentioned above, the first ring housing is capable of operating in different modes: the lock mode, the unlock mode, and an adjusting mode. FIGS. 6A to 6C are schematic views of the car mount operating in a unlock mode. FIG. 6A depicts the first ring housing 500 operating in the unlock mode. In the unlock mode, side lugs (referring to FIG. 2B) contacts the platform 511 and 521, respectively. Please refer to FIG. 6C, FIG. 6C is a cross-sectional view taken along line A-A of FIG. 6B. As shown in FIG. 6C, when the first ring housing is in the unlock mode, the first gear structure 255 and the second gear structure 455 are separated, and the main body 300 can depart from the base assembly 200. Besides, the plurality of second springs 212 is disposed under the pressing part 251. The plurality of second springs 212 can support the pressing part 251 while the rotor 400 moving downward to press the pressing part 251. In other words, the pressing part has flexibility and is capable of slightly moving upward or downward.

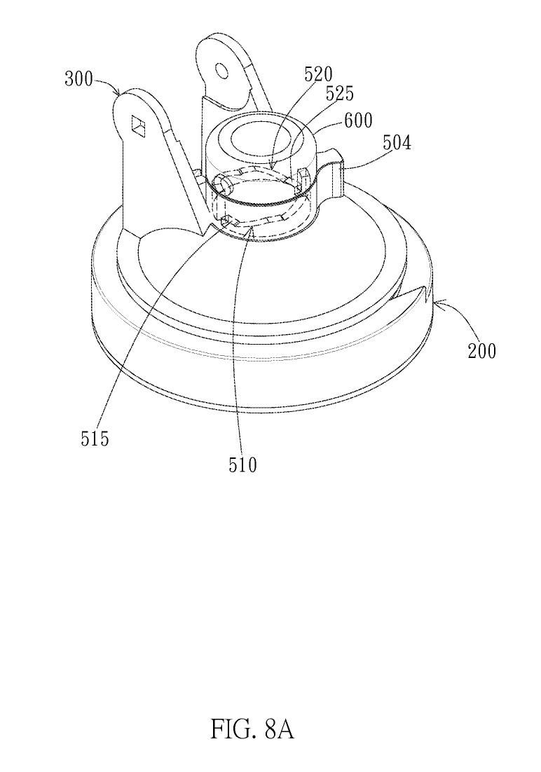

FIGS. 7A to 7C are schematic views of the car mount operating in an adjusting mode. FIG. 7C is a cross-sectional view taken along line B-B of FIG. 7B. FIG. 7A depicts the first ring housing 500 operating in the adjusting mode. In the adjusting mode, the holder 504 is turned in a counter-clockwise direction, and side lugs (referring to FIG. 2B) contacts the platform 513 and 523, respectively. Please refer to FIG. 7C, FIG. 7C is a cross-sectional view taken along line B-B of FIG. 7B. As shown in FIG. 7C, when the first ring housing is in the adjusting mode, the rotor 400 moves toward the supporting surface 222, and the second gear structure 455 partially contacts the first gear structure 255. As shown in the enlarged cross-sectional drawing, the first gear structure 255 and the second gear structure 455 are in a form of triangle. The first gear structure 255 has a number of teeth having a first inclined surface 2551 and a second inclined surface 2552. The second gear structure 455 has a number of teeth having a third inclined surface 4551 and a fourth inclined surface 4552. The third inclined surface 4551 partially contacts the second inclined surface 2552. When a user rotate the main body 300 under the adjusting mode, the third inclined surface 4551 will downwardly press the second inclined surface 2552. At this time, the pressing part will slightly move downward, and the third inclined surface 4551 can moves to contact another inclined surface of another tooth of the first gear structure 255. In other words, in the adjusting mode, the main body 300 is fixed to the base assembly 200 while the user can rotate the main body 300 with respect to the base assembly 200 (shown in FIG. 7A, the broken line through arms 340).

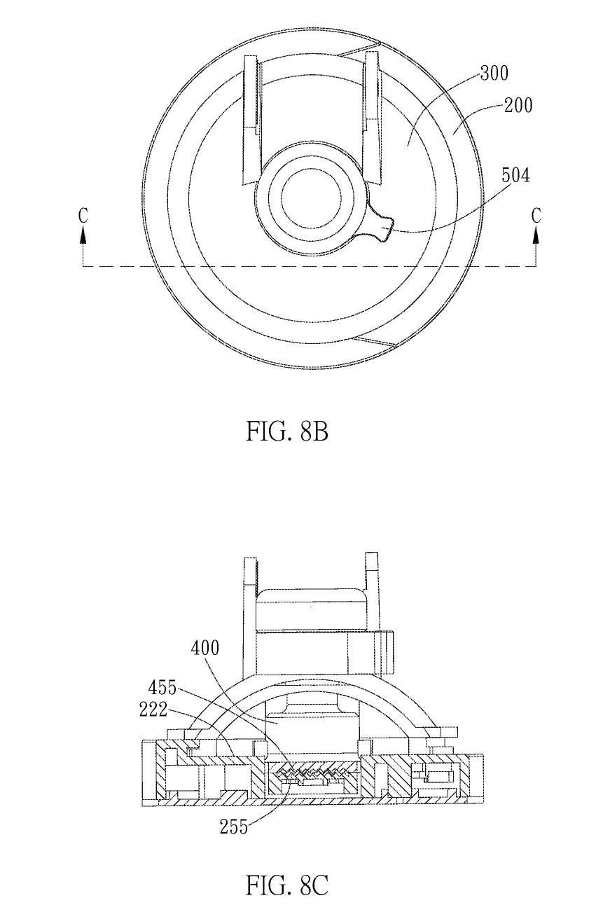

FIGS. 8A to 8C are schematic views of the car mount operating in a lock mode. FIG. 8C is a cross-sectional view taken along line C-C of FIG. 8B. FIG. 8A depicts the first ring housing 500 operating in the unlock mode. In the unlock mode, the holder 504 is turned in a counter-clockwise direction, and side lugs (referring to FIG. 2B) contacts the platform 515 and 525, respectively. Please refer to FIG. 8C, FIG. 8C is a cross-sectional view taken along line C-C of FIG. 8B. As shown in FIG. 8C, when the first ring housing 500 is in the lock mode, the rotor 400 moves toward the supporting surface 222 and the first gear structure 255 engages the second gear structure 255. After choosing a require position of the main body 300 in the adjusting mode, the user can turn the holder 504 to fix the main body 300. As such, the main body 300 cannot rotate with respect to the base assembly 200.

If the user wants to change the position of the main body 300 after the main body 300 is locked, the user can turn the holder 504 in a clockwise direction. Therefore, the rotor 400 will move upwardly, and the second gear structure 455 will partially contacts the first gear structure 255 (the adjusting mode, shown in FIG. 7C). As such, the main body 300 can rotate with respect to the base assembly 200. Similarly, if the user further turns the holder 504 in the clockwise direction, the rotor 400 moves away from the supporting surface 222, and the first gear structure 255 disengages from the second gear 455 (the unlock mode, shown in FIG. 6C). As such, the main body 300 can be removed from the base assembly 200.

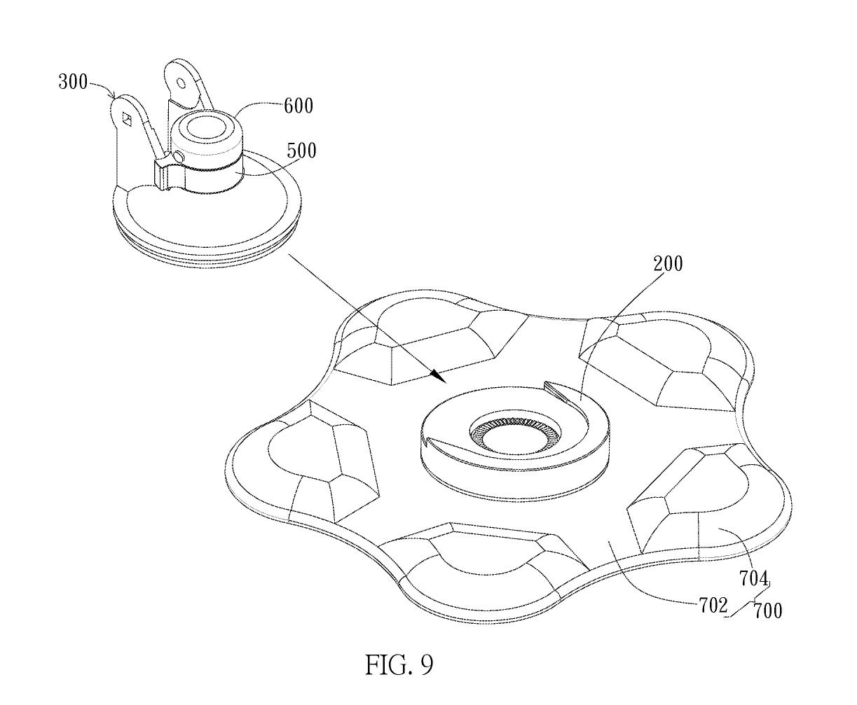

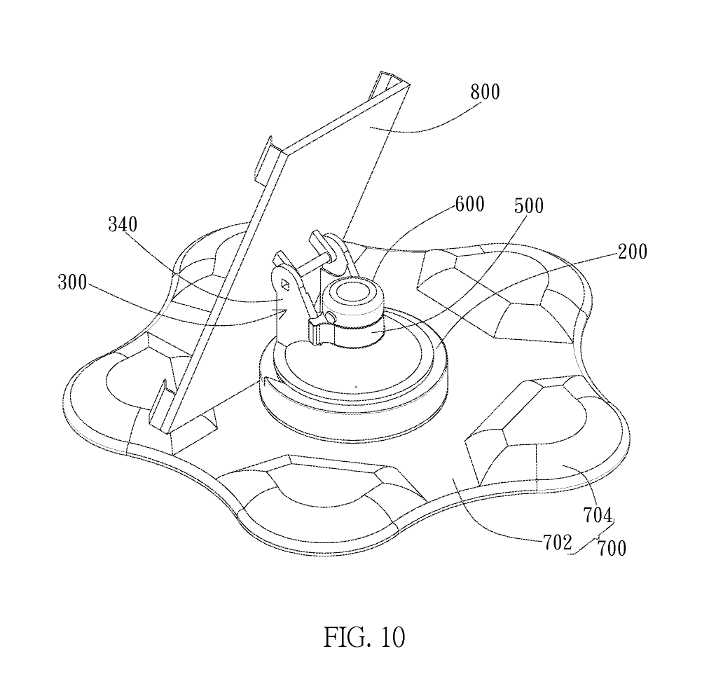

FIGS. 9 and 10 are application scenarios of the present invention. FIG. 9 is a schematic view of an embodiment of the main body combining a base assembly. FIG. 10 is schematic view of an embodiment of the car mount of the present invention. As shown in FIG. 9, the car mount further includes a friction pad 700. The friction pad 700 includes a flat surface 702 and a plurality of bags 704 located at corners of the friction pad 700. The plurality of bags 704 can sustain the friction pad 700 onto a disposing surface. The base assembly 200 is preferably fixed to the flat surface 702. As shown in FIG. 9, the main body 300 is put in the base assembly 200, and as shown in FIG. 10, a case 800 is then combined with arms 340. The user can put the electronic device into the case 800 and turn the first ring housing 500 to set the main body at a required position. By this design, the structural stability of the car mount can be enhanced, and it is more safety for the user while driving.

Although the preferred embodiments of the present disclosure have been described herein, the above description is merely illustrative. Further modification of the disclosure herein disclosed will occur to those skilled in the respective arts and all such modifications are deemed to be within the scope of the disclosure as defined by the appended claims.

What is claimed is:

1. A car mount for fixing an electronic device, the car mount comprising:
a base assembly having a supporting surface and a first gear structure disposed corresponding to the supporting surface;
a main body including a cover, the main body being disposed on the supporting surface, the cover having a peripheral part, wherein the cover retreats inwardly from the peripheral part along a direction opposite to the base assembly to form a recession space;
a rotor including an axle body and a second gear structure, the axle body being accommodated in the recession space, a part of the axle body protruding through the cover along the direction opposite to the base assembly, the second gear structure is formed on a surface of the rotor facing the supporting surface; and
a first ring housing rotatably disposed on the main body and connecting the part of the axle body protruding through the cover; wherein the first ring housing is capable of operating in a lock mode and an unlock mode for driving the rotor approaching to or departing from the supporting surface.

2. The car mount of claim 1, wherein when the first ring housing is in the lock mode, the rotor moves toward the supporting surface and the first gear structure engages the second gear structure; when the first ring housing is in the unlock mode, the rotor moves away from the supporting surface and the first gear structure disengages from the second gear structure.

3. The car mount of claim 1, wherein the first ring housing is further capable of operating in an adjusting mode, when the first ring housing is in the adjusting mode, the rotor moves toward the supporting surface and the second gear structure partially contacts the first gear structure.

4. The car mount of claim 1, wherein the base assembly comprises:
a bottom plate;
a base comprising a supporting plate and an outer sidewall connected a periphery of the supporting plate; wherein the base is disposed on the bottom plate, the supporting plate inwardly forms a recession part from the outer sidewall, the supporting plate encircles with respect to the center of the base and forms a hollow area.
a pressing plate comprising an outer surface and disposed inside the recession part, the outer surface corresponding to the hollow area, and the first gear structure being formed on the outer surface.

5. The car mount of claim 4, wherein the base comprises a top plate disposed on the supporting plate, the top plate connects the outer sidewall and forms a curved opening along the periphery of the supporting plate.

6. The car mount of claim 1, wherein the axle body is hollow and has a shoulder portion, the rotor comprises:
a core shaft disposed on a top portion of the axle body;
at least one side lug disposed at the shoulder portion and connected the core shaft;
a pressing disc connected a bottom periphery of the axle body, the second gear structure formed on a surface of the pressing disc facing the supporting surface;
a groove formed on an inner surface of the axle body;
a first cross rod engaging in the groove.

7. The car mount of claim 6, further comprising a second ring housing, the second ring housing comprising:
at least one through hole formed on a sidewall of the second ring housing along a radial direction;
a second cross rod penetrating the through hole and disposed in the second ring housing;
a first spring hooking one end on the second cross rod and hooking the other end on the first cross rod.

8. The car mount of claim 1, wherein the main body comprising:
an axle cover having a sidewall and disposed on the cover, the axle cover having a concave part inside thereof and communicating the recession space, the sidewall having an opening and the part of the axle body protruding through the opening;
an upper ring connected the cover along the peripheral part;
a lower ring connected a bottom part of the cover and has a height difference with respect to the upper ring, the lower ring being attached to the supporting surface;
at least one arm disposed on the cover and extended away from the center of the cover.

9. The car mount of claim 1, wherein the first ring housing comprises a tread formed on an inner surface of the first ring housing, the tread includes a plurality of platforms spacedly disposed at different height.
